(19) United States
(12) Patent Application Publication
(10) Pub. No.: US 2026/0254001 A1
(43) Pub. Date: Aug. 27, 2026

(54) A BATTERY PACK

(71) Applicant: TVS MOTOR COMPANY LIMITED, Chennai (IN)

(72) Inventors: Santosh Gavhane, Chennai (IN); Raghuraman Shyam Kousik, Chennai (IN); Anjali Haridas, Chennai (IN); P Kambi Reddy, Chennai (IN); Manish Garg, Chennai (IN); Ayan Shree, Chennai (IN); Kandregula Srinivasa Rao, Chennai (IN); N Pramila Rao, Chennai (IN)

(73) Assignee: TVS MOTOR COMPANY LIMITED, Chennai (IN)

(21) Appl. No.: 18/879,402

(22) PCT Filed: Nov. 10, 2022
(86) PCT No.: PCT/IN2022/050986

§ 371 Date: Dec. 27, 2024

(30) Foreign Application Priority Data
Jun. 27, 2022 (IN) 202241036842

(51) Int. Cl. H01M 10/667; H01M 10/42; H01M 10/613; H01M 10/6551; H01M 50/204; H01M 50/278; H01M 50/287

(52) U.S. Cl. CPC H01M 10/667; H01M 10/425; H01M 10/613; H01M 10/6551; H01M 50/204; H01M 50/278; H01M 50/287; H01M 2010/4271

(57) ABSTRACT

A battery pack includes a plurality of battery cells electrically coupled to each other, a BMS module adapted to manage the plurality of battery cells, a casing adapted to house the plurality of battery cells, a top cover adapted to cover the casing and accommodate the BMS module, and a heat sink in thermal contact with the BMS module. The heat sink is mounted on at least one first portion of the BMS module and embedded in the top cover, or the heat sink is integrally en-moulded in at least a second portion of the top cover. The heat sink is adapted to dissipate heat from the BMS module to an outside of the casing and the top cover.

### FIELD OF THE INVENTION

The present invention generally relates to a battery pack and more particularly relates to a top cover, a BMS module and a heat sink of the battery pack.

### BACKGROUND OF THE INVENTION

Advancement in electric and hybrid electric vehicle technology has ushered in a new era of vehicles being run on stored electrical energy. Generally, a battery pack acts as energy source of the electric vehicle. The battery pack includes a plurality of battery cells electrically interconnected to each other. A Battery Management System (BMS) plays a vital role in managing the battery pack and monitoring its health. The BMS is an electronic system that manages a rechargeable battery pack to protect it by preventing the battery pack from operating outside its safe operating ranges, monitoring its state, calculating secondary data, reporting data gathered, controlling its environment, authenticating and/or balancing it, etc. The BMS monitors voltage, charging current, temperature, state of charge, and the like of the battery cells of the battery pack to ensure effective working and longevity of the battery pack.

The BMS is constituted of many electronic components which generate heat while in operation. The BMS remains operational in all instances where the battery pack remains operational. Thus, during vehicle driving condition when the battery pack discharges energy or during vehicle charging condition when the battery pack accumulates energy, the BMS is operational and generates significant amount of heat. The BMS is conventionally a Printed circuit board (PCB) with various electrical and electronic components embedded therein including Metal Oxide Semiconductor Field Effect Transistors (MOSFETs). The various electrical and electronic components embedded in the BMS, heats up during operation of the BMS and release heat. Furthermore, the battery cells of the battery pack also generate heat while in operation and add to the heat generated by the BMS, resulting in heat build-up in the battery pack. This poses a risk of failure of the entire battery pack. For safe and reliable operation of the battery pack, the BMS must be maintained within its safe temperature limits. Otherwise, it may lead to failure of the BMS, thus compromising the longevity of the battery pack. A failure of the BMS may even lead to fatal accidents putting life of operators and passengers of the vehicle at risk.

In existing designs, a heat sink may be provided in the battery pack by mounting it on the PCB of the BMS. However, the entire assembly of the heat sink and BMS would be disposed inside the battery pack surrounded by stagnant air. Air being a very bad conductor of heat, does not allow heat to dissipate from the heat sink, thereby concentrating and increasing heat build-up in the BMS. Further, the battery pack being hermetically sealed for safety reasons also work contrary to efficient heat dissipation. Hot air remains stuck inside the battery pack as stagnant hot air. With passage of time, the heat sink becomes less effective in dissipating heat, generated in the BMS, and also temperature of the battery pack as well as the BMS increases due to the surrounding stagnant hot air. Further, higher temperatures in the battery pack negatively affect the plurality of battery cells of the battery pack decreasing battery pack performance and causing customer dissatisfaction.

Also, a case and its cover for the battery cells of the battery pack is generally made of resin material and hence does not conduct heat effectively. Therefore, the entire battery pack keeps heating up leading to very high temperatures and longer cooling period, during operation and charging of the vehicle. Other obvious solutions to this problem would be changing material used for the case and its cover of the battery pack to metal and/or using a fan for cooling. However, this leads to higher weight of the battery pack and more power consumption, also addition of more parts results in overall increase in cost of the battery pack. Therefore, it is imperative to ensure effective dissipation of heat generated by the BMS in an efficient manner to ambient environment outside the battery pack to avoid failure of the BMS and consequently the battery pack.

Thus, there is a need in the art for a battery pack having an efficient and cheap heat dissipation mechanism for the BMS of the battery pack which addresses at least the aforementioned problems.

### SUMMARY OF THE INVENTION

In one aspect, the present invention is directed to a battery pack. The battery pack includes a plurality of battery cells which are electrically coupled to each other and a BMS module adapted to manage the plurality of battery cells. A casing adapted to house the plurality of battery cells and a top cover adapted to cover the casing is provided for the battery pack. The top cover is further adapted to accommodate the BMS module and a heat sink. The heat sink is adapted to dissipate heat from the BMS module to an outside of the casing and the top cover. The heat sink is in thermal contact with at least one first portion of the BMS module. In an embodiment, the heatsink is mounted on at least the one first portion of the BMS module and embedded in the top cover. In another embodiment, the heat sink is integrally en-moulded in at least a second portion of the top cover.

In a further embodiment, the casing includes a base portion and four side faces. The four side faces extend orthogonally from edges of the base portion to form the casing. The top cover is disposed opposite to the base portion to cover the casing.

In another embodiment, the plurality of battery cells are stacked in rows, such that a length of the plurality of battery cells is parallel to the base portion of the casing and the top cover. Also, a width of each of the plurality of battery cells is parallel to any of the side faces of the casing. In an embodiment, the BMS module is disposed adjacent to a distal row of the plurality of battery cells.

In yet another embodiment, the top cover includes a cut-out which is adapted to receive the heat sink and a corresponding gasket. The gasket is adapted to prevent entry of water and dust into the casing through the cut-out of the top cover. In an embodiment, the heat sink is affixed within the cut-out of the top cover and the gasket is affixed at a periphery of the cut-out.

In a further embodiment, the heat sink includes an inner face disposed on the BMS module and an outer face exposed to the outside of the casing. The inner face is thermally coupled to the BMS module. The outer face is adapted to dissipate heat to atmosphere outside the casing and is provided with a plurality of fins exposed to the outside of the casing. In an embodiment, the plurality of fins are pin fins. In another embodiment, the heat sink is of a substantial T shaped profile when viewed in a direction perpendicular to the top cover.

In a further embodiment, the BMS module includes a base member having a plurality of electrical and electronic components interconnected for controlling operation of the battery pack. Furthermore, the base member has a first surface facing towards the plurality of battery cells and a second surface being opposite to the first surface, facing towards the top cover.

In an embodiment, the heat sink is mounted on the base member of the BMS module such that the inner face of the heat sink is in thermal contact with the second surface of the base member.

In another embodiment, a plurality of heat dissipating electronic components of the BMS module is mounted on at least a portion of the first surface of the base member, and opposite to the inner face of the heat sink. Heat generated in the plurality of heat dissipating electronic components is dissipated to the heat sink.

In a further embodiment, the heat sink is made of a metallic material and the top cover is made of a resin material.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a top perspective view of an exemplary battery pack, in accordance with an embodiment of the present invention.

FIG. 2 illustrates a top view of the battery pack, in accordance with an embodiment of the present invention.

FIG. 3 illustrates a side elevation view of the battery pack, in accordance with an embodiment of the present invention.

FIG. 4 illustrates a cross sectional view of a top portion of the battery pack at a plane A indicated in FIG. 2 and viewed along an Z axis of the battery pack, in accordance with an embodiment of the present invention.

FIG. 5 illustrates another cross sectional view of the top portion of the battery pack at a plane B indicated in FIG. 2 and viewed along an X axis of the battery pack, in accordance with an embodiment of the present invention.

FIG. 6 illustrates a top perspective view of an exemplary top cover of the battery pack, in accordance with an embodiment of the present invention.

FIG. 7 illustrates an exploded view of the top cover of the battery pack, in accordance with an embodiment of the present invention.

FIG. 8 illustrates a top perspective view of an exemplary heat sink of the battery pack, in accordance with an embodiment of the present invention.

FIG. 9 illustrates a schematic cross sectional view of the top portion of the battery pack at the plane B indicated in FIG. 2 and viewed along the X axis of the battery pack, in accordance with an embodiment of the present invention.

### DETAILED DESCRIPTION OF THE INVENTION

Various features and embodiments of the present invention here will be discernible from the following further description thereof, set out hereunder. The present invention generally relates to a battery pack and more particularly relates to a top cover, a BMS module and a heat sink of the battery pack.

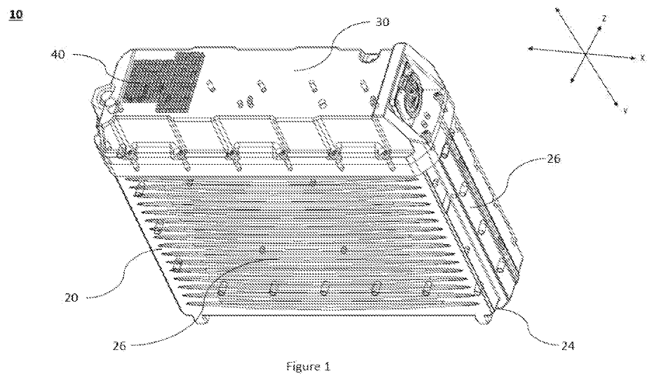

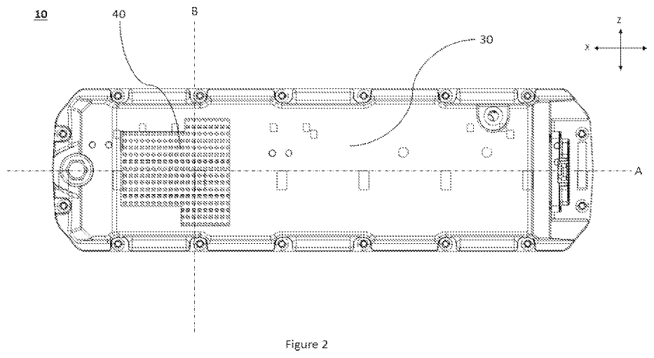

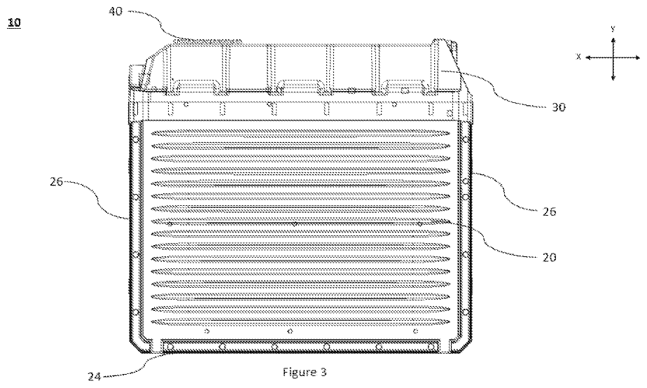

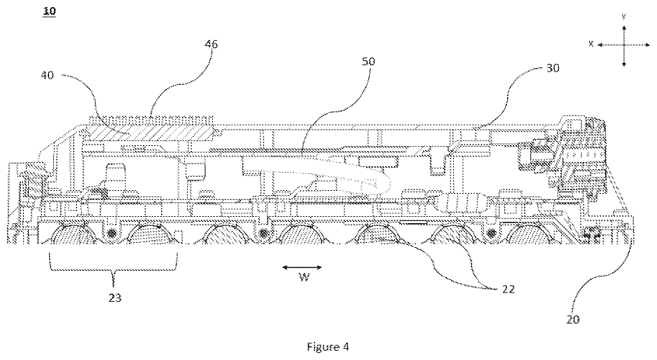

FIG. 1 illustrates a top perspective view of an exemplary battery pack 10, in accordance with an embodiment of the present subject matter. The battery pack 10 includes a plurality of battery cells 22 (shown in FIG. 4) which are electrically coupled to each other. In an embodiment, the plurality of battery cells 22 may be grouped into one or more battery modules of the battery pack 10. The illustrated embodiment indicates X, Y and Z axes of the battery pack 10. FIG. 2 illustrates a top view of the battery pack 10, and FIG. 3 illustrates a side elevation view of the battery pack 10, in accordance with an embodiment of the present subject matter. Referring to FIG. 2, two imaginary planes A and B are defined along the Y axis of the battery pack 10 for cross sectional division of the battery pack 10. The plane A is parallel to the X axis and the plane B is parallel to the Z axis respectively of the battery pack 10. Referring to FIGS. 1, 2 and 3, the battery pack 10 includes a casing 20 which is adapted to house the plurality of battery cells 22 and a top cover 30. The top cover 30 is adapted to cover the casing 20 from a top portion. In an embodiment, the casing 20 is of cuboidal shape. The casing 20 includes a base portion 24 and four side faces 26 extending orthogonally from edges of the base portion 24. The casing 20 is open at the top portion opposite the base portion 24 such that the plurality of battery cells 22 and other electrical and electronic components of the battery pack 10 are received within the casing 20 via the open top portion. In the illustrated embodiment, the top cover 30 is disposed opposite to the base portion 24 to cover the casing 20 at the open top portion of the casing 20. Further the Y axis of the battery pack 10 is perpendicular to the base portion 24 and the top cover 30. In another embodiment, the four side faces 26 extending orthogonally from edges of the base portion 24 of the casing 20 are adapted to receive and secure the top cover 30 to the casing 20. In yet another embodiment, the casing 20 and the top cover 30 are constituted of a resin material.

FIG. 4 illustrates a cross sectional view of a top portion of the battery pack 10 at the plane A indicated in FIG. 2 and viewed along the Z axis of the battery pack 10, in accordance with an embodiment of the present subject matter. The plurality of battery cells 22 are stacked in multiple rows. The plurality of battery cells 22 are stacked such that, a length of the plurality of battery cells 22 is parallel to the base portion 24 of the casing 20 and the top cover 30. In the illustrated embodiment, the length of the plurality of battery cells 22 is parallel to the Z axis of the battery pack 10. Further, a width W of each of the plurality of battery cells 22 is parallel to any of the side faces 26 of the casing 20. In the illustrated embodiment, the width W of each of the plurality of battery cells 22 is parallel to the shorter pair among the four side faces 26 of the casing 20, i.e., the width W of each of the plurality of battery cells 22 is parallel to the X axis of the battery pack 10. In another embodiment, a BMS module 50 is disposed adjacent to a distal row 23 of the plurality of battery cells 22 in the battery pack 10.

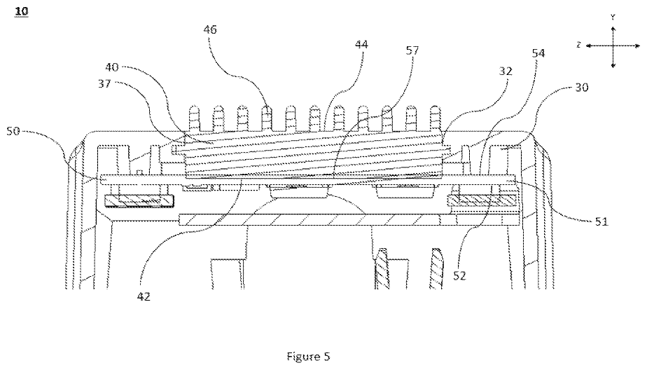

FIG. 5 illustrates a cross sectional view of the top portion of the battery pack 10 at the plane B indicated in FIG. 2 and viewed along the X axis of the battery pack 10, in accordance with an embodiment of the present subject matter. The battery pack 10 includes the BMS module 50 which is adapted to manage the plurality of battery cells 22. The BMS module 50 monitors voltage, charging current, temperature, state of charge, and the like of the plurality of battery cells 22 and keeps them within safe operational range to ensure effective working and longevity of the plurality of battery cells 22 and consequently the battery pack 10. In the illustrated embodiment, the BMS module 50 is accommodated within the top cover 30. The battery pack 10 includes a heat sink 40 which is in thermal contact with at least one first portion 57 of the BMS module 50. The heat sink 40 is adapted to dissipate heat from the BMS module 50 to an outside of the casing 20 and the top cover 30. In an embodiment, the heat sink 40 includes an inner face 42 which is disposed on the BMS module 50. The inner face 42 of the heat sink 40 is also thermally coupled to the BMS module 50 so as to conduct heat away from the BMS module 50 to a body of the heat sink 40. The heat sink 40 further includes an outer face 44 with a plurality of fins 46. The plurality of fins 46 is exposed to the outside of the casing 20 and top cover 30 and is adapted to dissipate heat to atmosphere outside the casing 20 and the top cover 30. Thus, the heat generated in the BMS module 50 is transmitted to the heat sink 40 and effectively dissipated to atmosphere outside the casing 20 and the top cover 30 via the plurality of fins 46.

In an embodiment, the BMS module 50 includes a base member 51 with a plurality of electrical and electronic components interconnected therewith for controlling operation of the battery pack 10. The base member 51 is a Printed circuit board (PCB) with the plurality of electrical and electronic components, including Metal Oxide Semiconductor Field Effect Transistors (MOSFETs), embedded therein. In the illustrated embodiment, the base member 51 includes a first surface 52 which faces towards the plurality of battery cells 22 and a second surface 54 which is opposite to the first surface 52. The second surface 54 faces towards the top cover 30. In an embodiment, the heat sink 40 is mounted on the base member 51 of the BMS module 50 and the inner face 42 of the heat sink 40 is in thermal contact with the second surface 54 of the base member 51. In another embodiment, the heat sink 40 is mounted only on a portion of the base member 51 and the plurality of electrical and electronic components are mounted on the remaining area of the base member 51. A thermal paste may be applied at the interface between the second surface 54 of the base member 51 and the inner face 42 of the heat sink 40 for effective heat dissipation.

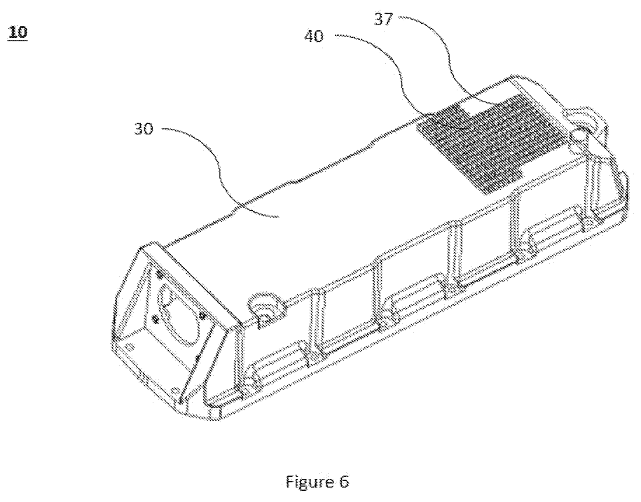

FIG. 6 illustrates a top perspective view of an exemplary top cover 30 of the battery pack 10, in accordance with an embodiment of the present subject matter. The heatsink 40 is integrally en-moulded in at least a second portion 37 of the top cover 30. This ensures that the top cover 30 and the heatsink 40 forms one integral unit without any gaps in between, allowing for a hermetically sealed assembly of the battery pack 10.

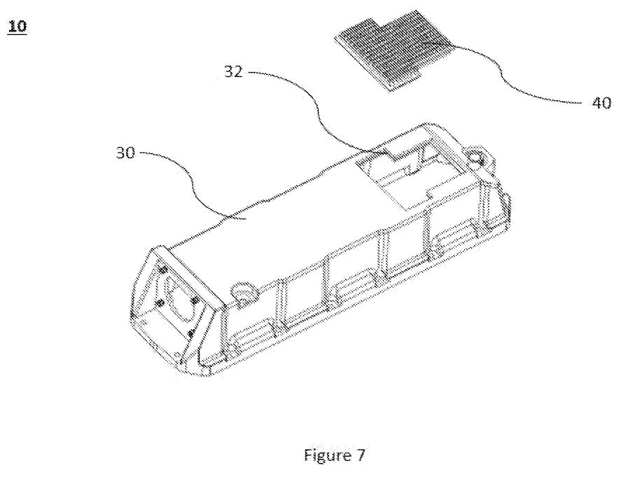

FIG. 7 illustrates an exploded view of the top cover 30 of the battery pack 10, in accordance with an embodiment of the present subject matter. The heatsink 40 is mounted on at least the one first portion 57 (shown in FIG. 5) of the BMS module 50 and embedded in the top cover 30. In an embodiment, the top cover 30 includes a cut-out 32 which is adapted to receive the heat sink 40 and a gasket (not shown). The heat sink 40 is affixed within the cut-out 32 of the top cover 30. The gasket is affixed at a periphery of the cut-out 32 and the gasket is adapted to prevent entry of water, dust, and any foreign particle into the casing 20 through the cut-out 32 of the top cover 30. In this case the top cover 30 is moulded separately from the heat sink 40, and they are mechanically assembled by mounting the heat sink 40 in the cut-out 32. The gasket aids in waterproofing the battery pack 10 at the side of the top cover 30. In yet another embodiment, the heat sink 40 is glued to the top cover 30 to be disposed within the cut-out 32 using an adhesive. The adhesive performs the purpose of affixing the heat sink 40 to the top cover 30 and also seals the edges of the cut-out 32 to hermetically seal the interface.

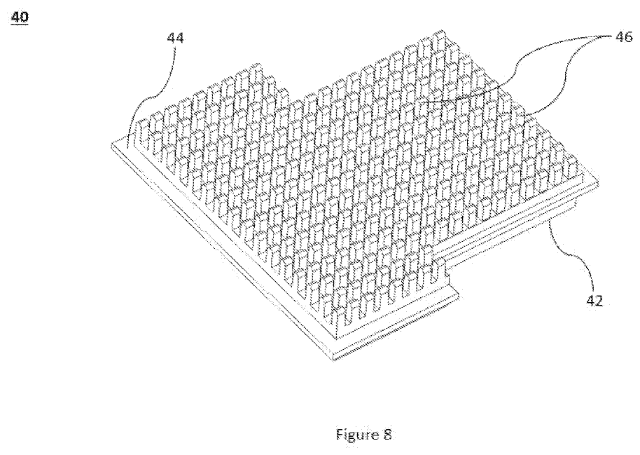

FIG. 8 illustrates a top perspective view of an exemplary heat sink 40 of the battery pack 10, in accordance with an embodiment of the present subject matter. In an embodiment, the heat sink 40 has a substantial T shaped profile (also shown in FIG. 2) when viewed in a direction perpendicular to the top cover 30. The T shaped profile of the heat sink 40 is designed to provide for effective heat dissipation from the BMS module 50 without compromising on the strength and integrity of the top cover 30. In another embodiment, the plurality of fins 46 on the outer face 44 of the heat sink 40 are pin fins. Pin fins provide more surface area for heat dissipation, thus increasing the efficacy in cooling the BMS module. In yet another embodiment, the heat sink 40 is constituted of a metallic material. Metallic materials like Aluminium which are conductive, and lightweight are preferred. By ensuring that the fins 46 of the heat sink 40 are exposed outside the battery pack 10, effective cooling of the BMS module 50 is achieved as the fins 46 are capable of direct conduction, convection, and radiation of accumulated heat to an environment outside the battery pack 10.

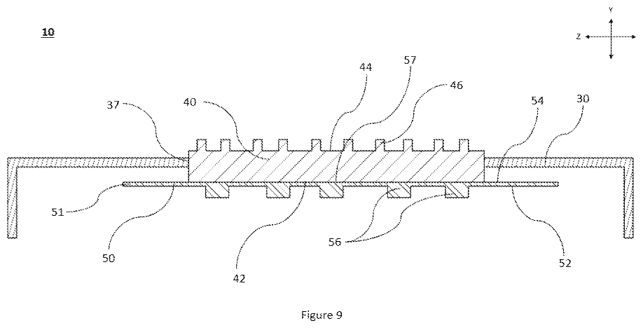

FIG. 9 illustrates a schematic cross sectional view of the top portion of the battery pack 10 at the plane B indicated in FIG. 2 and viewed along the X axis of the battery pack 10, in accordance with an embodiment of the present subject matter. A plurality of heat dissipating electronic components 56 of the BMS module 50 are mounted on at least a portion of the first surface 52 of the base member 51 for dissipating heat generated in the plurality of heat dissipating electronic components 56 to the heat sink 40. Thus, the plurality of heat dissipating electronic components 56 of the BMS module 50 are mounted opposite to the inner face 42 of the heat sink 40 and heat generated in the plurality of heat dissipating electronic components 56 are transmitted through the BMS module 50 to the second surface 54 of the base member 51 to be dissipated away to the heat sink 40. In an embodiment, the plurality of heat dissipating electronic components 56 may be mounted on the second surface 54 of the base member 51, at the same side as that of the inner face 42 of the heat sink. In an embodiment, the plurality of heat dissipating electronic components 56 consists of MOSFETs. MOSFETs generates the maximum thermal energy that needs to be dissipated as they are the major source of heat production in the BMS module 50.

Advantageously, the present claimed invention provides a battery pack and an improved design of a top cover for the casing of the battery pack with a heat sink provided in the top cover to effectively dissipate heat generated predominantly in the BMS module of the battery pack to the outside ambient environment. The claimed invention provides a direct conduction path through the heat sink from the heat source, which is the BMS module, to ambient environment. This enables effective and efficient heat dissipation. Since the heat sink is integrated with the top cover of the battery pack, number of constituent child parts required for a heat sink assembly in the battery pack is reduced. This leads to a reduction in overall weight and cost of the battery pack. Efficient heat dissipation by the heat sink prevents entrapment of heat within the confines of the battery pack and ensures that the battery system runs within intended operating temperatures, leading to improvement in product longevity, durability, and performance, while also ensuring safety. Further, the claimed invention proposes effective passive cooling of the BMS module, thereby eliminating the requirement for any external active energy source for cooling the BMS module. Hence, the present mechanism as claimed is simple and economical. Integrating the heat sink with the top cover forms a sub assembly which makes the assembly process easier. Since the claimed system dissipates heat efficiently, thermal mass required for the heat sink is comparatively less.

The claimed configurations of the battery pack as discussed above are not routine, conventional, or well understood in the art, as the claimed configurations of the battery pack enable the following solutions to the existing problems in conventional technologies. Specifically, the present invention achieves effective heat dissipation of heat generated predominantly in the BMS module of the battery pack. It provides a direct conduction path through the heat sink from the heat source, which is the BMS module, to ambient environment. This enables effective and efficient heat dissipation. Efficient heat dissipation by the heat sink prevents entrapment of heat within the confines of the battery pack and ensures that the battery system runs within intended operating temperatures, leading to improvement in product longevity, durability, and performance, while also ensuring safety.

While the present invention has been described with respect to certain embodiments, it will be apparent to those skilled in the art that various changes and modifications may be made without departing from the scope of the invention as defined in the following claims.

### LIST OF REFERENCE NUMERALS

10—battery pack
20—casing
22—plurality of battery cells
23—a distal row of the plurality of battery cells in the battery pack
24—base portion of the casing
26—side faces of the casing
30—top cover
32—cut-out of the top cover
37—a second portion of the top cover
40—heat sink
42—inner face of the heat sink
44—outer face of the heat sink
46—plurality of fins
50—BMS module
51—base member of the BMS module
52—first surface of the base member
54—second surface of the base member
56—heat dissipating electronic components of the BMS module
57—one first portion of the BMS module
W—width of each of the plurality of battery cells
X, Y, Z—axes of the battery pack
A, B—imaginary planes defined for cross sectional division of the battery pack

1-14. (canceled)

15. A battery pack comprising:
a plurality of battery cells electrically coupled to each other;
a battery management system (BMS) module configured to manage the plurality of battery cells;
a casing configured to house the plurality of battery cells;
a top cover configured to cover the casing and accommodate the BMS module; and
a heat sink in thermal contact with at least one first portion of the BMS module, wherein the heat sink is:
mounted on the at least one first portion of the BMS module and embedded in the top cover, or
integrally en-moulded in at least a second portion of the top cover,
the heat sink is configured to dissipate heat from the BMS module to an outside of the casing and the top cover.

16. The battery pack as claimed in claim 15, wherein the casing comprises:
a base portion; and
four side faces extending orthogonally from edges of the base portion to form the casing.

17. The battery pack as claimed in claim 16, wherein the top cover is disposed opposite to the base portion to cover the casing.

18. The battery pack as claimed in claim 17, wherein
the plurality of battery cells is stacked in rows,
a length of the plurality of battery cells is parallel to the base portion of the casing and the top cover, and
a width of each of the plurality of battery cells is parallel to any of the four side faces.

19. The battery pack as claimed in claim 18, wherein the BMS module is disposed adjacent to a distal row of the plurality of battery cells.

20. The battery pack as claimed in claim 15, wherein the top cover includes a cut-out configured to receive the heat sink and a gasket.

21. The battery pack as claimed in claim 20, wherein
the heat sink is affixed within the cut-out of the top cover,
the gasket is affixed at a periphery of the cut-out, and
the gasket is configured to prevent entry of water and dust into the casing through the cut-out.

22. The battery pack as claimed in claim 15, wherein the heat sink comprises:
an inner face disposed on the BMS module and thermally coupled to the BMS module; and
an outer face with a plurality of fins exposed to the outside of the casing and configured to dissipate heat to atmosphere outside the casing.

23. The battery pack as claimed in claim 22, wherein the plurality of fins is pin fins.

24. The battery pack as claimed in claim 17, wherein the heat sink is a substantial T shaped profile when viewed in a direction perpendicular to the top cover.

25. The battery pack as claimed in claim 19, wherein
the BMS module comprises a base member with a plurality of electrical and electronic components interconnected for controlling operation of the battery pack,
a first surface of the base member faces towards the plurality of battery cells, and
a second surface of the base member is opposite to the first surface and faces towards the top cover.

26. The battery pack as claimed in claim 25, wherein
the heat sink is mounted on the base member of the BMS module, and
an inner face of the heat sink is in thermal contact with the second surface of the base member.

27. The battery pack as claimed in claim 26 further comprising:
a plurality of heat dissipating electronic components of the BMS module mounted on at least a portion of the first surface of the base member, opposite to the inner face of the heat sink, for dissipating heat generated in the plurality of heat dissipating electronic components to the heat sink.

28. The battery pack as claimed in claim 15, wherein
the heat sink is a metallic material, and
the top cover is a resin material.
